(19) United States
(12) Patent Application Publication
(10) Pub. No.: US 2008/0120904 A1
(43) Pub. Date: May 29, 2008

(54) Plate-like support, and a show and exhibition device, a display device, a flower stand and a seedling-growth device using the same

(76) Inventors: Shinichi Takahashi, Kochi-shi (JP); Takashi Ike, Kochi-shi (JP)

Correspondence Address: QUINN EMANUEL;KODA & ANDROLIA, 865 S. FIGUEROA STREET, 10TH FLOOR, LOS ANGELES, CA, 90017, US

(21) Appl. No.: 11/507,853

(22) Filed: Aug. 22, 2006

(51) Int. Cl. A01G 9/02

(52) U.S. Cl. 47/65.8

(57) ABSTRACT

A plate-like support (2) is provided with a number of accommodating spaces (7) arranged along its surfaces. Two sets of spiral wires (4) are arranged perpendicular to each other, thereby forming a mesh member (5). This mesh member (5) forms the plate-like support (2) having a first surface (2a) and a second surface (2b) between which framework members (6) are disposed. These framework members (6) partition the accommodating spaces (7) so as to envelop them. The accommodating spaces (7) are formed over a space between the first surface (2a) and the second surface (2b), each of which is provided with openings (8), and adjoin the adjacent accommodating spaces (7) through the framework members (6). The framework members (6) are opened to provide communication portions (10), through which the adjacent accommodating spaces (7, 7) communicate with each other.

### BACKGROUND OF THE INVENTION

The present invention concerns a plate-like support as well as a show and exhibition device or other various devices using this plate-like support and more particularly relates to a plate-like support as well as to a show and exhibition device, a display device, a flower stand and a seedling-growth device, each of which has a simple structure able to sufficiently protect a number of substances to be accommodated, from falling down due to contact with other substances while accommodating them so as to make them visible and to support them stably in a narrow area of installation.

In the case of showing and exhibiting goods or the like, there is a method of exhibiting by superposing them one on another. In this case, the goods or the like are arranged horizontally. Therefore, there is a problem that it requires a large area for installing the show and exhibition device.

In order to solve the above problem, there is an example of conventional show and exhibition devices, which comprises a plate-like support formed from a metal mesh or the like. The plate-like has one surface from which suspending support rods project like cantilevers so that independent goods are suspended from those rods (see Utility Model Registered No. 3016021).

More specifically, as for this conventional show and exhibition device, the package member for packaging the good or the like is opened to provide a suspending hole, through which the suspending rod is inserted for The purpose of showing and exhibiting it.

However, this conventional show and exhibition device has the following problems.

(1) The package member is suspended from the suspending rod like a cantilever. This separates the center of gravity of the show and exhibition device from a surface of the plate-like support to entail a need of providing, for example, a sure support portion which supports the plate-like support in its wide area so that this plate-like support can be installed upright stably. This results in increasing the area for installation

(2) The support rod projects from the plate-like support, so that this support rod contacts the other substances to easily hook them. Further, the package member is suspended from the support rod and therefore comes to easily contact the other substances to entail a likelihood of dropping them.

(3) The plate-like support has many suspending rods projecting therefrom to become complicated in form. Besides, when a stopper or the like is provided so as to prevent the package member from falling down due to the contact mentioned above, it becomes more complicated in form to result in a problem that it cannot be put into practice at a low cost.

(4) The package member is formed with the suspending hole or the like. This entails a problem that the package member becomes so large as to enlarge the show and exhibition device in size.

Additionally, as for the seedling-growth device which grows a number of seedlings, the plate-like support is concaved at many portions to provide a number of spaces for accommodation, each of which accommodates a seedling (for example, see Japanese Patent Application Laid-Open (Kokai) No. 11-113416). This seedling-growth device is arranged horizontally in order that the sun light or the like can be emitted to every accommodating space as well as the water and the fertilizer can be supplied thereto. This causes a problem that it requires a large area of installation.

### SUMMARY OF THE INVENTION

The present invention has an object to provide a plate-like support as well as a show and exhibition device, a display device, a flower stand and a seedling-growth device using the same, each of which has a simple structure able to sufficiently protect a number of substances to be accommodated from falling down due to contact with other substances, while accommodating them so as to make them visible and to support them in a narrow area stably.

In order to accomplish the above object, the present invention is constituted as follows, if it is explained, for example, based on FIGS. 1 to 11 which show embodiments of the present invention.

The plate-like support of the present invention relates to a plate-like support which is made of a mesh member 5 and has a number of accommodating spaces arranged along its surfaces. The mesh member 5 is formed from a plurality of spiral wires 4, which comprises two sets arranged perpendicular to each other. In each of the two sets, the wires are arranged parallel mutually. Each of the wires 4 has a coil pitch (p) set to a dimension of being substantially two times a coil diameter (d) and is entangled mutually between a first surface 2a and a second surface 2b. The entanglement of the spiral wires 4 forms a plurality of framework members 6 between the first surface 2a and the second surface 2b. The framework members 6 partition the accommodating spaces 7 so as to envelop them. Each of the accommodating spaces 7 is formed over a space between both of the surfaces 2a and 2b. At least one of the surfaces 2a is opened to provide openings 8. The accommodating spaces 7 adjoin the adjacent spaces 7 through the framework members 6.

The plate-like support is formed only by entangling the plurality of spiral wires mutually to form the framework members between the both surfaces. Therefore, it is simply constructed and besides offers a high rigidity owing to the framework members. The accommodating space adjoins the adjacent one through this framework member. A plurality, for example, 9 to 100, of or more accommodating spaces are arranged and formed along the surfaces of the plate-like support to be concentrated so highly as to fully embed the surfaces. And all the accommodating spaces or optional ones accommodate the substances to be accommodated. The respective substances to be accommodated in the respective accommodating spaces are visible through the openings.

The framework members are disposed between both of the surfaces and don't project from either of the surfaces. This prevents them from hooking the other substances even if the former contact the latter. Besides, the accommodating spaces are enveloped and partitioned by the framework members. Therefore, the substance to be accommodated within the accommodating space is inhibited from contacting the other substance.

Since the accommodating spaces are formed between the both surfaces, even if many substances to be accommodated are accommodated within these accommodating spaces, the center of gravity of the whole entity is positioned between the both surfaces. As a result, the plate-like support is easily and stably installed upright by, for example, posts fixed onto the both sides thereof and besides is readily carried while accommodating the substances to be accommodated as they are when they have to be moved.

The framework member is opened to provide a communication portion, through which the adjacent accommodating spaces are communicated with each other. In this case, the substance to be accommodated within the accommodating space is maintained while it is partially fitted into the communication portion. Moreover, the accommodating space is excellent in air-permeability and water-permeability because the framework member enveloping the accommodating space is provided with the opening and the communication portion. For instance, even if it is exposed to strong wind or heavy rain outside the building, these wind and rain pass through the plate-like support and therefore can hardly blow it away. This can reduce the damage it suffers from due to the wind and rain.

The communication portion is ordinarily formed smaller than the opening. This allows the substance to be accommodated to freely go into and out of the accommodating space through the opening. Besides, within the accommodating space, even if the substance fits into the communication portion, it doe not enter the adjacent accommodating space through the communication portion and is surely accommodated into the specific accommodating space.

The respective accommodating spaces can be arranged side by side linearly in a horizontal direction as well as in a vertical direction. In this case, the substances to be accommodated can be arranged side by side orderly so that they can present a good appearance and in addition can be easily controlled in quantity. Therefore, this is preferable.

Particularly, in the case where the framework member is provided with the communication portion, when the respective accommodating spaces are arranged side by side linearly in the horizontal direction, it is possible to simply accommodate a substance to be accommodated far longer than an accommodating space by inserting it through the plural accommodating spaces arranged side by side in the horizontal direction. Further, when the respective accommodating spaces are arranged side by side linearly in the vertical direction, it is possible to simply support the plate-like support in an upright position by inserting a post or the like through the plural accommodating spaces arranged in series in the vertical direction.

Although the respective spiral wires may be fixed to each other by spot-welding or the like, they are substantially constrained only through entangling the two sets of wires perpendicular to each other. This makes it possible to obviate the welding and the like fixing process. This case offers the following advantages.

(1) The spiral wires don't have to be connected together by welding or the like, which results in getting rid of the likelihood that they suffer from the strain and the deterioration due to heating upon welding.

(2) Since the spiral wires don't have to be connected together, even if the load of the substances to be accommodated and the external stress are applied thereto, they relatively shift at the entangled portions. As a result, the plate-like support damps the load and the stress in its entirety. Consequently, there is no probability that the wires break or the excessive load is applied to the post or the like with the result of enhancing the durability.

(3) The mesh member is formed by entangling the respective spiral wires together. Accordingly, even if the wires partly break, it is possible to easily remedy the broken portions through manual working or the like.

The plate-like support accommodates the substances to be accommodated within the accommodating spaces and allows them to go into and out of the accommodating spaces through the openings, thereby enabling itself to be used as a show and exhibition device.

In this case, many substances to be accommodated can be accommodated within the accommodating spaces formed along the surfaces of the plate-like support. Besides, it is possible to see and confirm the substances to be accommodated through the openings.

The plate-like support accommodates the display elements within the accommodating spaces and make those display elements visible through the openings, thereby enabling itself to be used for a display device.

In this case, since the accommodating spaces mutually adjoin through the framework members, the display elements accommodated within the accommodating spaces can form a continuous pattern and therefore can display a letter, a design, a pattern or the like various shapes depending on their arrangement. Usable for these display elements are, for example, color balls, balloons, flower vases, eggs, electric bulbs or the like product of substantially a constant size. Thus it is possible to obtain a novel visual effect which was not offered by the conventional one.

Additionally, in the event that the goods are used for the display elements and are combined with the function of show and exhibition, it can more enhance the interest of the purchaser to result in increasing the sales opportunity and the purchasing desire.

The plate-like support accommodates the flower vases within the accommodating spaces and makes the weeds and flowers within the flower vase visible through the openings, thereby enabling itself to be used for the flower stand. In this case, the framework members are provided with the openings and the communication portions, so that the sun light, air, water and the like are readily supplied through these openings and communication portions to thereby easily maintain the plants within the flower vases under the good circumstances for growth.

As regards the flower vases, notwithstanding the fact that a narrow installation area is sufficient for the reason of using the plate-like support, it is possible to decorate the plate-like support over its wide surface with weeds and flowers by arranging many flower vases filled with small weeds and flowers within all the accommodating spaces or optional ones. Thus it offers a visual effect which was conventionally absent, and therefore is usable for the display device.

The plate-like support accommodates the seedling-growth vessel within the accommodating space, thereby enabling itself to be used for the seedling-growth device.

In this case, the plate-like support can be positioned upright and therefore does not require a wide installation area. Further, every accommodating space is provided with an opening to thereby offer a good air-permeability. Besides, even if the plate-like support is positioned slant or upright, the sun light, water, fertilizer and the like can be supplied through the opening with the result of being able to grow the seedling to be accommodated within every accommodating space in good condition.

### EFFECT OF THE INVENTION

The present invention is constructed and functions as mentioned above. Thus it offers the following effects.

(1) The accommodating spaces are arranged and formed along the surfaces so that they can be highly concentrated and can accommodate the substances to be accommodated at optional positions on the surfaces depending on the design or the like. Further, the substances to be accommodated within the accommodating spaces can be seen easily through the openings.

(2) It is made of the mesh member formed from spiral wires and has so simple a structure that these spiral wires are entangled perpendicular to each other to form framework members between the both surfaces. Thus it is sufficient if a small number of parts are used. In addition, since the spiral wires need not be welded together by welding or the like, it can be put into practice at a low cost. Further, the framework members formed by entangling the spiral wires offer so high a rigidity that they surely maintain the shape of a predetermined surface, flat or curved.

(3) The framework members are disposed between the both surfaces so as not to project therefrom and besides are formed by entangling the spiral wires with the result of providing the plate-like support with no corner, which obviates the fear of damaging the person or the other substance that has contacted therewith. Further, even if it contacts the other substance, it can be inhibited from hooking the substance.

Besides, the wire being spiral, even if it is thin, it can form a framework member of high strength. In addition, the substance to be accommodated within the accommodating space is enveloped by this framework member, so that it is inhibited from contacting the other substance with the result of being able to obviate the fear of dropping due to contact with the other substance and therefore to protect the substance to be accommodated in a good condition.

(4) The framework members formed by entangling the spiral wires can offer a high rigidity to thereby assuredly retain the shape of a predetermined surface, flat or curved. Further, since the framework members can be formed by thin wires, the plate-like support is light and handled easily, and besides can make the adjacent accommodating spaces much more closer mutually to concentrate them. Moreover, the substance to be accommodated within the accommodating space has its center of gravity positioned between the both surfaces. Therefore, even in a state where a number of substances to be accommodated are accommodated, it can be positioned upright easily and stably in a narrow installation area by, for example, posts fixed to the opposite sides. Further, when it is moved, it can be transported easily and stably with many substances to be accommodated retained within the accommodating spaces.

### BRIEF DESCRIPTION OF THE DRAWINGS

FIG. 1 is a partly broken perspective view of a show and exhibition device showing a first embodiment of the present invention;

FIG. 2 is a partly broken perspective view of the first embodiment with the vicinity of an accommodating space enlarged;

FIG. 3 shows essential portions of a plate-like support of the first embodiment. FIG. 3(a) is an enlarged front view of the vicinity of the accommodating space and FIG. 3(b) is a sectional view taken along a line B-B in FIG. (3a) when seen in a direction indicated by arrows;

FIG. 4 shows a first modification. FIG. 4(a) is a perspective view of the show and exhibition device of the first modification and FIG. 4(b) is a perspective view of a show and exhibition device according to a second modification. FIG. 4(c) is a perspective view of a show and exhibition device according to a third modification;

FIG. 5 is a front view of a display device showing a second embodiment of the present invention;

FIG. 6 is a front view of a flower stand showing a third embodiment of the present invention;

FIG. 7 is a front view of the flower stand of the third embodiment with essential portions of the flower stand enlarged;

FIG. 8 is a vertical sectional side view of the flower stand of the third embodiment with essential portions enlarged;

FIG. 9 is a front view of a seedling-growth device showing a fourth embodiment of the present invention;

FIG. 10 is a perspective view of a seedling-growth vessel of the fourth embodiment; and

FIG. 11 is a vertical sectional view of the fourth embodiment with the vicinity of an accommodating space enlarged.

### MOST PREFERRD EMBODIMENT OF THE INVENTION

Hereafter, an embodiment of the present invention is explained based on the drawings.

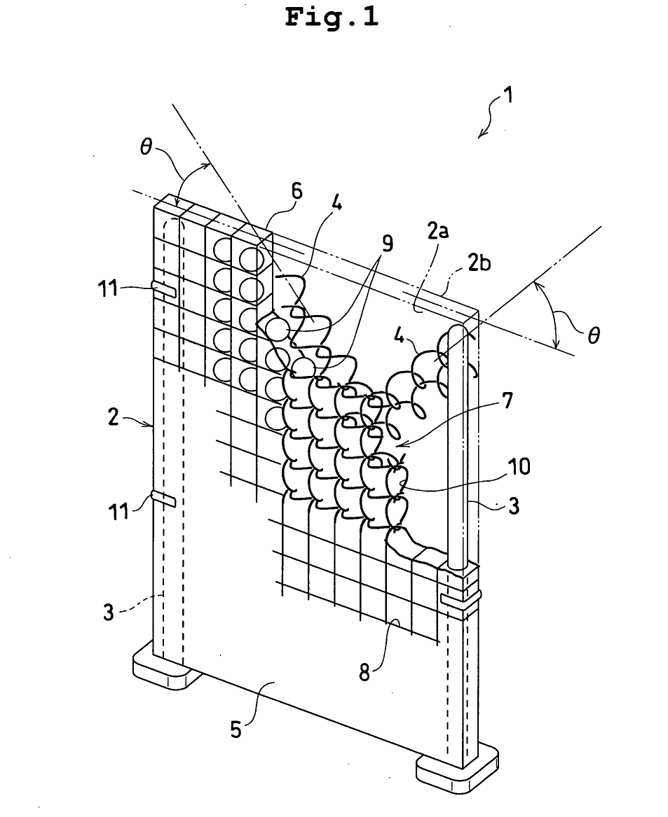

FIGS. 1 to 3 show a first embodiment where a plate-like support according to the present invention is applied to a show and exhibition device.

FIG. 1 is a partly broken perspective view of the show and exhibition device.

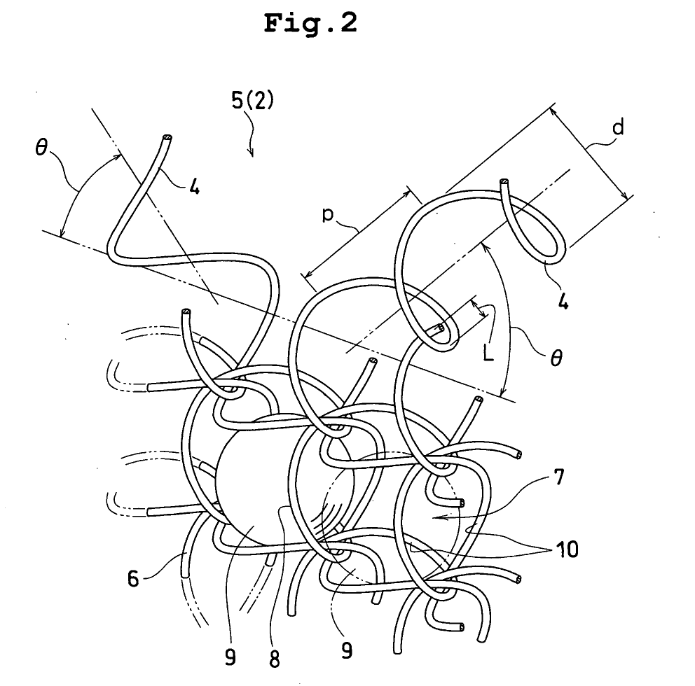

FIG. 2 is an enlarged partly broken perspective view of the vicinity of an accommodating space.

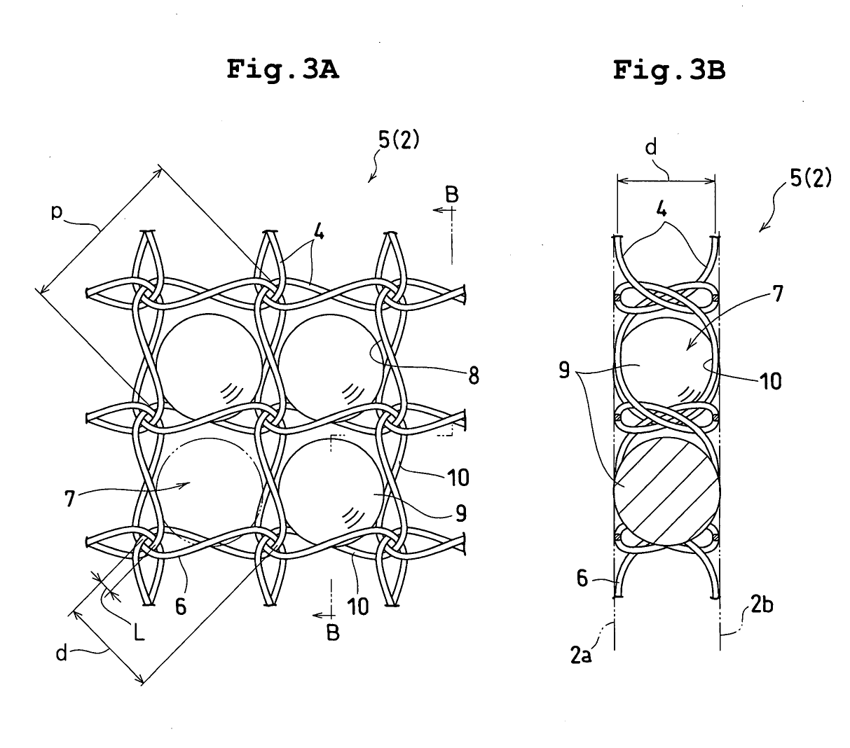

FIG. 3 shows essential portions of the plate-like support. FIG. 3a is an enlarged front view of the vicinity of the accommodating space and FIG. 3b is a sectional view taken along a line B-B in FIG. 3(a) when seen in a direction indicated by arrows.

As shown in FIG. 1, this show and exhibition device 1 comprises a plate-like support 2 formed flat in a rectangular shape when seen from the front and posts 3 supporting the plate-like support 2 upright.

The plate-like support 2 comprises a mesh member 5 formed by entangling a plurality of spiral wires 4 together. These spiral wires 4 are entangled together to form a number of framework members 6 between a first surface 2a and a second surface 2b. And a number of accommodating spaces 7 are partitioned in such a manner that they are enveloped by the framework members 6 and are arranged along the both surfaces 2a and 2b.

As shown in FIGS. 1 and 2, the respective accommodating spaces 7 are formed over a space between the both surfaces 2a and 2b which are provided with openings 8. A substance 9 to be accommodated within an accommodating space 7 goes into and out of the accommodating space 7 through an opening 8. In this embodiment, although both of the surfaces 2a and 2b are provided with the openings 8, only one of them may be provided with the openings and the other may be closed by a plate-like member arranged along the plate-like support.

The accommodating spaces 7 are arranged side by side linearly in a horizontal direction as well as in a vertical direction. The respective accommodating spaces 7 are arranged to be so highly concentrated that they can adjoin the accommodating spaces adjacent thereto vertically and horizontally through the framework members 6. For example, 9 to 100 or more accommodating spaces 7 are formed in the rectangular plate-like support 2 having a side of 600 to 3000 mm. The framework member 6 is opened to provide a communication portion 10, through which the adjacent accommodating spaces 7, 7 communicate with each other.

In this embodiment, the plate-like support 2 is formed rectangular. However, according to the present invention, the plate-like support may be formed in optional shapes like the polygonal, circular, eclipse and variable other than square and rectangle. Its size is freely set depending on the dimension and the number of the substances to be accommodated. The accommodating spaces are not limited to those arranged linearly in the horizontal direction as well as in the vertical direction.

On the opposite sides of the plate-like support 2, the posts 3 are inserted through a series of accommodating spaces 7 in continuity vertically, thereby surely supporting the plate-like support 2 upright. These posts 3 may be simply inserted into the series of accommodating spaces 7 or they may be fixed to the framework members 6 by connections or the like fixing means 11 for stable support. Further, this post 3 may be inserted into the plate-like support 2 at a mid portion in a right and left direction for support.

This embodiment has used the post 3 as a means for supporting the plate-like support 2. However, according to the present invention, the supporting means may consist of a fixed frame disposed around the plate-like support instead of the post 3. Alternatively, the plate-like support may be supported by being suspended from or fixed to the other structure. In addition, this plate-like support and the post supporting the same may be provided with casters or the like, thereby enabling them to be carried.

As shown in FIG. 2, the spiral wires 4 forming the mesh member 5, each of which is inclined at an angle of 45 degrees with respect to a horizontal plane, comprise two sets arranged perpendicular to each other. The spiral wires in each of the two sets are arranged parallel to each other and entangled together between the first surface 2a and the second surface 2b.

The spiral wire 4 has a coil pitch (p) set to a dimension of about two times a coil diameter (d), more specifically to a dimension of about two times a value obtained by deducting a dimension of entanglement (L) from the coil diameter (d). This entangles the spiral wires 4 of one set with those 4 of the other set at a position where the spiral wires in each of the sets are entangled with one another, namely between the first surface 2a and the second surface 2b.

According to the present invention, the respective spiral wires 4 may be fixed together by spot-welding or the like. However, since in this embodiment, the respective spiral wires 4 can be substantially constrained only by combining two sets of wires perpendicular to each other, the welding or the like fixing process is omitted. This makes the production step simple enough to be able to put it into practice inexpensively. Besides, it is unnecessary to subject the spiral wires 4 to an excessive heat load. In addition, the respective spiral wires 4 shift slightly and relatively, so that when the load of the substances to be accommodated and the external stress are applied, they are distributed over the entirety of the plate-like support and therefore are damped.

The coil diameter (d) is set depending on the size of the substance to be accommodated, for example, to about 20 to 100 mm. The thickness of the spiral wire 4 is set in view of the strength required to protect the substance to be accommodated 9. For example, if it is made of a metal, the thickness of about 1.2 to 6.0 mm is adopted. However, needless to say, the thickness and coil diameter of the spiral wire to be used for the present invention are not limited to those dimensions.

The spiral wire 4 is made of synthetic resin, glass or a composite material of these synthetic resin and glass other than a metal and therefore is not limited to a specific material. However, for example, when adopting, for example, a material with resiliency and rigidity each of which is of proper degree like a metal wire or a metal wire coated with synthetic resin, it exerts an excellent automorphic-property to protect the interior area of the accommodating space as well as a good damping ability when the load of the substance to be accommodated and the external stress are applied.

Every framework member 6 which envelops an accommodating space 7 comes to substantially a square having a dimension of one side of about 1.4 times the coil diameter (d), as shown in FIG. 3, and in other words, having a length of a diagonal line substantially identical to the coil pitch (p), when seen from the front.

On the other hand, as shown in FIG. 3(b), when seen from the side or from the top, it comes to substantially an ellipse which has a short axis of a dimension identical to the coil pitch (d) and has a long axis of a dimension of about 1.4 times the coil diameter (d). The length of this short axis, namely the dimension of the coil diameter (d), comes to about a distance between the both surfaces 2a and 2b. Four spiral wires 4 are mutually entangled between the both surfaces 2a and 2b, so that the communication portion 10 provided by opening this framework member 6 has a length shorter than that of the long axis. In consequence, this communication portion 10 is quite narrower than the opening 8 provided by opening the both surfaces 2a and 2b. As a result, the substance to be accommodated which has been inserted through the opening 8 is fitted without passing through the communication portion 10 to be supported therein.

In this embodiment, the whole substance to be accommodated 9 is accommodated within the accommodating space 7. Therefore, the framework 6 can protect the substance to be accommodated 9 well. However, according to the present invention, this substance 9 may be accommodated within the accommodating space 7 while it partly projects from the opening 8.

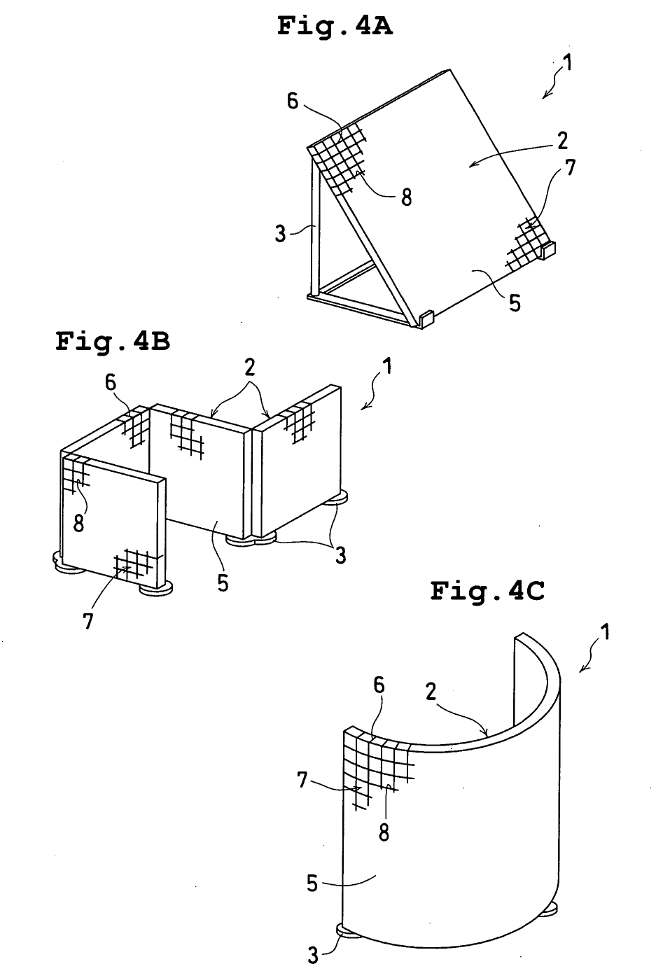

In the above embodiment, the plate-like support is formed like a flat surface and is made upright. However, according to the present invention, the shape and arrangement of the plate-like support are not limited to those of this embodiment and may be formed like a modification shown in FIG. 4.

More specifically, in a first modification shown in FIG. 4(a), the plate-like support of a flat surface is supported while it is inclined. In this case, if there is extra area for installation, it may be arranged horizontally.

Further, in a second modification shown in FIG. 4(b), a plurality of flat plate-like supports are arranged while they are bent. In this case, the flat plate-like supports are arranged so that they are bent mutually at an angle which is not limited to 90 degrees as shown in this modification but may be an optional one. Further, the plural plate-like supports may be combined so that they are arranged in the shape of a rectangular cylinder.

Besides, in a third modification shown in FIG. 4(c), the plate-like support 2 is curved. In this case, this plate-like support 2 may be formed in the shape of a cylinder.

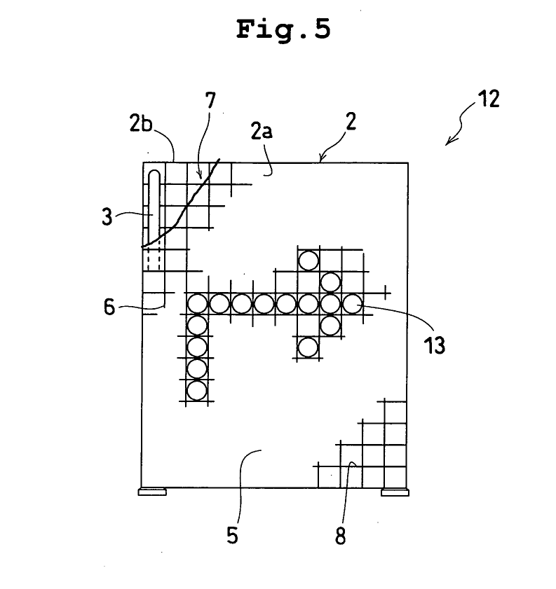

FIG. 5 shows a second embodiment and is a partly broken front view of a display device using the plate-like support.

As shown in FIG. 5, this display device 12 has the plate-like support 2 and the post 3 which supports the plate-like support 2 in an upright position as well as the first embodiment. A number of accommodating spaces 7 formed in this plate-like support 2 accommodate display elements 13 at predetermined positions in accordance with a design to be displayed so that these elements 13 are visible through the openings 8 of the accommodating spaces 7.

Usable for the display elements 13 are, for example, color balls, balloons, flower vases with weeds and flowers, eggs, electric bulbs or the like. However, they are not limited to specific substances but substances of substantially constant size are employable.

The display elements 13 may be accommodated in either all of the accommodating spaces 7 or specific ones 7. This enables both or either of the surfaces 2a and 2b of the plate-like support 2 to display an optional letter, design, pattern or the like with the presence or absence of the display elements 13 or the color of the display elements 13. Additionally, if electric bulbs are used for the display elements 13, the pattern or the like which changes with the elapse of time is displayed by controlling on-off of them.

Further, if goods are used for the display elements 13, they are combined with the function of show and exhibition. This enhances the interest of the purchaser to result in increasing the sales opportunity and the purchasing desire.

The accommodating spaces 7 mutually adjoin so that they can present a beautiful appearance of the continuous pattern or the like. Besides, since the display elements 13 are only accommodated within the accommodating spaces 7, it is possible to simply change what is to be displayed by inserting them into other accommodating spaces 7 or replacing them with other display elements 13.

The others are constructed and function as well as the first embodiment. Accordingly, an explanation therefor is omitted.

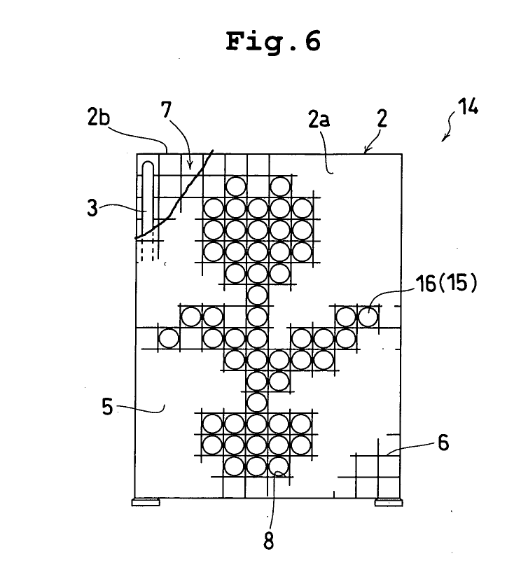

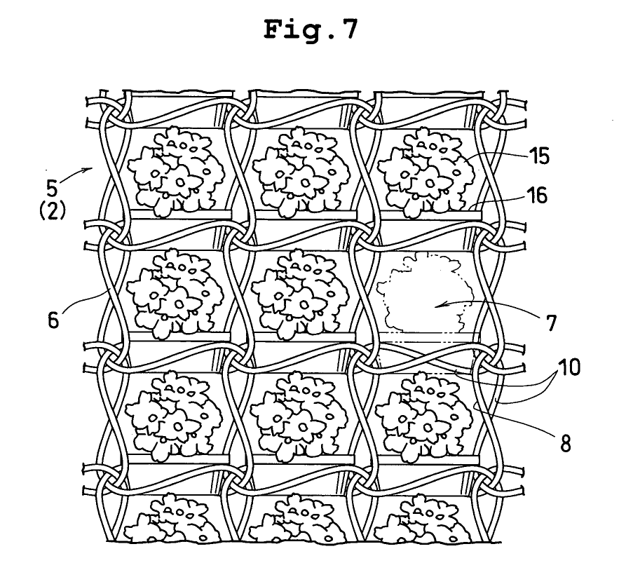

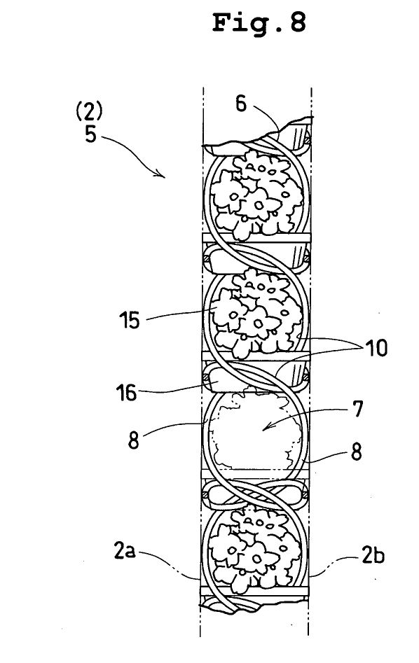

FIGS. 6 to 8 show a third embodiment where the plate-like support of the present invention is applied to a flower stand. FIG. 6 is a front view of the flower stand and FIG. 7 is a partly enlarged front view thereof. FIG. 8 is a vertical sectional side view of the flower stand with essential portions of the flower stand enlarged.

As shown in FIGS. 6 to 8, this flower stand 14 has the plate-like support 2 and the post 3 which supports the plate-like support 2 in an upright position as well as the first embodiment. A number of accommodating spaces 7 formed in the plate-like support accommodate flower vases 16 with weeds and flowers 15 which are visible through the openings 8 of the accommodating spaces 7.

Employable for the flower vases 16 are those in which weeds and flowers 15 can be planted or arranged. An example is a flower pot. These flower vases 16 to be accommodated within the accommodating spaces 17 are fitted into the communication portions 10 formed at under surfaces of the framework members 6, so that they are retained and protected surely. Therefore, even if the other substance contacts the plate-like support 2, it can hardly contact the flower vase 16 and the weeds and flowers 15 and does not cause the likelihood that the flower vase 16 falls down from the accommodating space 7.

The weeds and flowers 15 are simply supplied with the sun light, the air, the water and the like through the openings 8 and the communication portions 10. In consequence, they are maintained under good circumstances for growth, depending on the kind of the weeds and flowers 15. In the case where the weeds and flowers 15 die or are scattered independently, the flower vase 16 is taken out as a whole from the accommodating space 17. And the flower vase 16 with other weeds and flowers arranged is accommodated within this accommodating space 17, depending on the need.

The flower vases 16 can be arranged either in all or parts of the accommodating spaces 7. As a result, this flower stand 14 can decorate the plate-like support 2 over its wide surface with the weeds and flowers 15 in spite of the fact that the plate-like support 2 can be installed in a narrow area and therefore can offer a visual effect conventionally absent as an interior or an exterior. In this case, substances to be accommodated, other than the flower vases 16, may be accommodated within parts of the accommodating spaces 7 so as to enrich the color. Further, the plate-like support 2 can also serve as a display means by accommodating the flower vases 16 with weeds and flowers 15 of predetermined color within the predetermined accommodating spaces 7 with the aid of color of the weeds and flowers 15.

The others are constructed and function as well as the first embodiment. Accordingly, an explanation therefor is omitted.

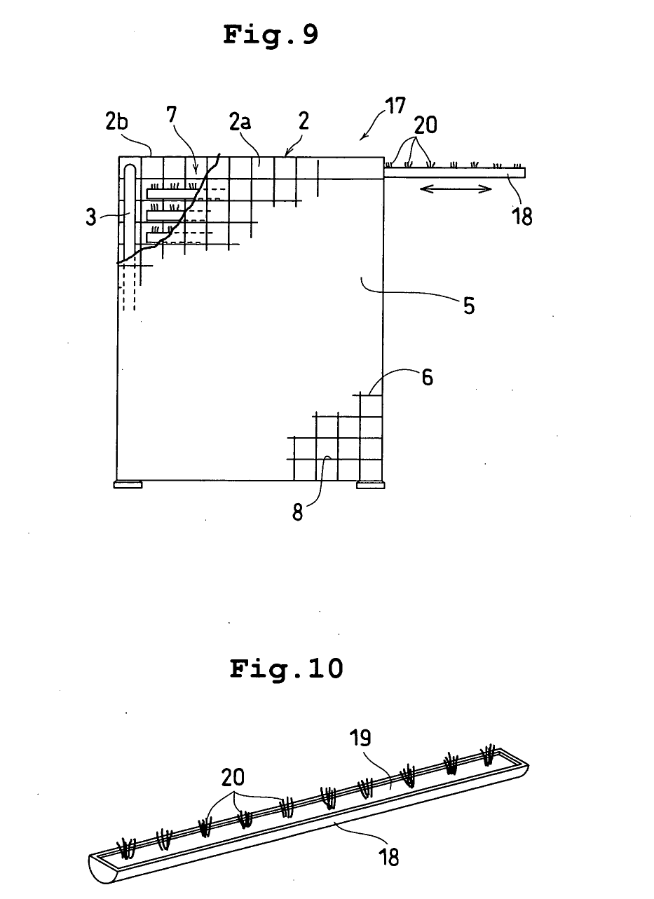

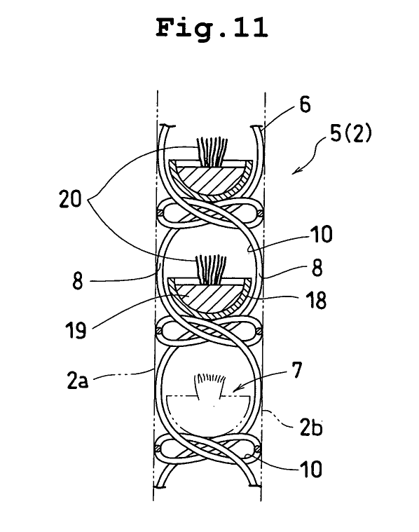

FIGS. 9 to 11 shows a fourth embodiment in which the plate-like support is applied to a seedling-growth device. FIG. 9 is a front view of the seedling-growth device and FIG. 10 is a perspective view thereof. FIG. 11 is a vertical sectional side view with the vicinity of an accommodating space 7 enlarged.

As shown in FIG. 9, this seedling-growth device17 has the plate-like support 2 and the post 3 which supports the plate-like support 2 in an upright position as well as the first embodiment. It further includes a plurality of seedling-growth vessels 18 to be inserted into the accommodating spaces in continuity horizontally.

As shown in FIG. 10, the seedling-growth vessel 18 has a semi-circular shape in cross section and is formed in the shape of a long trough opened at its upper surface. It is filled with nutrient medium 19 like earth and is fed with seeds or seedlings 20 at a proper spacing, preferably, in correspondence with a width between adjacent accommodating spaces 7.

As shown in FIG. 11, the accommodating space 7 is provided with the openings 8 and with the communication portions 10, so that the sun light, the air, the water, the fertilizer and the like are fed simply through the openings 8 and the communication portions 10 so as to keep the seedlings 20 or the like under the good circumstances for growth depending on the kind thereof.

When taking care of the nutrient medium 19, as shown in FIG. 9, the seedling-vessel 18 is taken out of the opening 10 provided by opening a side surface of the plate-like support 2. After it has been cared, it is inserted into the accommodating space 7 through the communication 10 as it was originally arranged.

The communication portion 10 is opened smaller than the opening 8 formed in the both surfaces 2a and 2b of the plate-like support as well as in the first embodiment. However, in this fourth embodiment, the long seedling-growth vessel 18 is supported by the communication portion 10 formed in the framework member 6. Therefore, this communication portion 10 may be opened approximately as large as or larger than the opening 8.

Although the long seedling-growth vessel 18 has been used in this fourth embodiment, according to the seedling-growth device of the present invention, this may be replaced with a pot-like seedling-growth vessel or the like. In this case, every seedling-growth vessel is accommodated within an independent accommodating space. Besides, the plate-like support 2 may be supported by the post 3 or the like while it is inclined. Alternatively, it may be supported by a suspending means or the like other supporting means. Furthermore, it may be formed into a structure able to be carried.

The others are constructed and function as well as the first embodiment. Accordingly, an explanation therefor is omitted.

The plate-like support as well as the show and exhibition device, the display device, the flower stand and the seedling-growth device explained in the above-mentioned embodiments are exemplified for embodying the technical idea of the present invention. In consequence, the material, the shape, the structure and the supporting means of the plate-like support, and the kind of the substance to be accommodated and the like are not limited to those used in these embodiments and various changes can be added thereto within the scope of claims of the present invention. For example, in each of the foregoing embodiments, the plate-like support is positioned upright on the earth. However, the present invention does not specify the place for arranging the plate-like support. Particularly, in the case of using it so as to enhance the visual effect, like the display device and the flower stand, it may be arranged while being suspended from a high place. Moreover, the plate-like support of the present invention can be installed in a narrow area even with its opposite surfaces formed wide, the above-mentioned show and exhibition device, display device and seedling-growth device can serve as a structure like a partition wall and so on.

The present invention can fully protect a number of substances to be accommodated by a simple structure while accommodating them so as to make them visible and can support them stably in a narrow installation area. In consequence, it is suitable for various sorts of show and exhibition devices, display devices, flower stands and seedling-growth devices.

What is claimed is:

1. A plate-like support made of a mesh member (5) and provided with a number of accommodating spaces (7) arranged along its both surfaces, wherein the mesh member (5) is formed from a plurality of spiral wires (4) comprising two sets arranged perpendicular to one another, in each of which the spiral wires are mutually arranged parallel, and the spiral wires (4), each of which has a coil pitch (p) set to a dimension of about two times a coil diameter (d), are entangled together between a first surface (2a) and a second surface (2b), thereby forming a plurality of framework members (6) between the first surface (2a) and the second surface (2b), the framework members (6) partitioning the accommodating spaces (7) so as to envelop them,
the accommodating spaces (7) being formed over a space between the first surface (2a) and the second surface (2b), at least one (2a) of which is provided with openings (8), and adjoining adjacent accommodating spaces (7) through the framework members (6).

2. The plate-like support as set forth in claim 1, wherein a framework member (6) is opened to provide a communication portion (10), through which the adjacent accommodating spaces (7,7) communicate with each other, and
the communication portion (10) is formed smaller than the opening (8).

3. A show and exhibition device which uses the plate-like support (2) as set forth in claim 1 or 2 and accommodates substances (9) to be accommodated within the accommodating spaces (7), the substances (9) to be accommodated being made to go into or out of the accommodating spaces (7) through the openings (8).

4. A display device which uses the plate-like support (2) as set forth in claim 1 or 2 and accommodates display elements (13) within the accommodating spaces (7), the display elements (13) being made visible through the openings (8).

5. A flower stand which uses the plate-like support (2) as set forth in claim 1 or 2 and accommodates flower vases (16) within the accommodating spaces (7), plants (15) within the flower vase (16) being made visible through the openings (8).

6. A seedling-growth device which uses the plate-like support (2) as set forth in claim 1 or 2 and accommodates seedling-growth vessels (18) within the accommodating spaces (7).
